(19) United States
(12) Patent Application Publication
(10) Pub. No.: US 2012/0039564 A1
(43) Pub. Date: Feb. 16, 2012

(54) Photoelectric Integrated Circuit Devices And Methods Of Forming The Same

(75) Inventors: Pil-Kyu Kang, Anyang-si (KR); GilHeyun Choi, Seoul (KR); Sukchul Bang, Yongin-si (KR); Daelok Bae, Seoul (KR); Byung-Lyul Park, Seoul (KR); KwangJin Moon, Suwon-si (KR); Dong-Chan Lim, Suwon-si (KR); Deok-Young Jung, Seoul (KR)

(73) Assignee: SAMSUNG ELECTRONICS CO., LTD., Suwon-si (KR)

(21) Appl. No.: 13/191,874

(22) Filed: Jul. 27, 2011

(30) Foreign Application Priority Data
Aug. 13, 2010 (KR) 10-2010-0078473

(51) Int. Cl. G02B 6/12

(52) U.S. Cl. 385/14

(57) ABSTRACT

A photoelectric integrated circuit device may include a substrate including an electronic device region and an on die optical input/output device region, the substrate having a trench in the on die optical input/output device region; a lower clad layer provided in the trench, the lower clad layer having an upper surface lower than a surface of the substrate; a core provided on the lower clad layer; an insulating pattern provided on the core; an optical detection pattern provided on the insulating pattern, the optical detection pattern having at least a portion provided in the trench; and at least one transistor provided on the substrate of the electronic device region.

### CROSS-REFERENCE TO RELATED APPLICATIONS

This U.S. non-provisional patent application claims priority under 35 U.S.C. §119 of Korean Patent Application No. 10-2010-0078473, filed on Aug. 13, 2010, the entire contents of which are hereby incorporated by reference.

### BACKGROUND

1. Field

The present inventive concepts herein relate to photoelectric integrated circuit devices and methods of aiming the same, and more particularly, to photoelectric integrated circuit devices including an on die optical input/output device and methods of forming the same.

2. Description of the Related Art

Generally, an optical device having an optical waveguide is formed using a silicon-on-insulator (SOI) substrate. A silicon-on-insulator (SOI) substrate is comprised of a silicon support layer, a silicon oxide layer and a single crystalline silicon layer. A silicon-on-insulator (SOI) substrate has a silicon oxide layer used as a lower clad layer which is already formed under a single crystalline silicon layer. Thus, after forming a core by etching a single crystalline silicon layer of an SOI substrate using a photoresist pattern, an upper clad layer is faulted on the SOI substrate to cover the core and thereby an optical device having an optical waveguide may be embodied.

However, since an SOI substrate is very expensive compared with a bulk silicon wafer, there is a limitation to commercialize the SOI substrate. In the case of an optical device having an optical waveguide embodied on an SOI substrate, integrating the optical device into a single substrate together with an electronic device such as a dynamic random access memory (DRAM) embodied on a bulk silicon wafer is difficult. Thus, to integrate an optical device having an optical waveguide and an electronic device having a memory into a single substrate, the optical device having the optical waveguide needs to be additionally packaged on a package substrate. Therefore, manufacturing a photoelectric integrated circuit device is economically and technically difficult.

### SUMMARY

An example embodiment of the inventive concepts provides a photoelectric integrated circuit device. The photoelectric integrated circuit device comprises a substrate including an electronic device region and an on die optical input/output device region, the substrate having a trench in the on die optical input/output device region; a lower clad layer provided in the trench, the lower clad layer having an upper surface lower than a surface of the substrate; a core provided on the lower clad layer; an insulating pattern provided on the core; an optical detection pattern provided on the insulating pattern, the optical detection pattern having at least a portion provided in the trench; and at least one transistor provided on the electronic device region.

An example embodiment of the inventive concepts also provides a method of forming a photoelectric integrated circuit device. The method comprises preparing a substrate including an electronic device region and an on die optical input/output device region, the substrate having a trench in the on die optical input/output device region; forming a lower clad layer having a top surface lower than a surface of the substrate in the trench; forming a core on the lower clad layer; forming an insulating pattern on the core; forming an optical detection pattern on the insulating pattern so that at least a portion of the optical detection pattern is provided in the trench; and forming at least one transistor on the electronic device region.

An example embodiment of the inventive concepts also provides a photoelectric integrated circuit device. The photoelectric integrated circuit device comprises a substrate including an on die optical input/output device region, the substrate having a trench in the on die optical input/output device region; and at least a portion of an optical detection pattern in the trench, the optical detection pattern having an upper surface the same height as the surface of the substrate.

### BRIEF DESCRIPTION OF THE FIGURES

The accompanying figures are included to provide a further understanding of the present invention, and are incorporated in and constitute a part of this specification. The drawings illustrate example embodiments and, together with the description, serve to explain principles of the present invention. In the figures:

FIG. 1A is a top plan view illustrating a photoelectric integrated circuit device including an on die optical input/output device.

FIG. 1B is an enlarged three dimensional view of “A” part of FIG. 1A.

FIG. 1C is a cross sectional view taken along a line of I-I′ of FIG. 1B.

FIGS. 2 through 22B are cross sectional views illustrating methods of forming an on die optical input/output device in accordance with example embodiments of the inventive concepts.

FIG. 23 is a block diagram illustrating an example of memory system fitted with a memory including photoelectric integrated circuit devices in accordance with example embodiments of the inventive concepts.

FIG. 24 is a block diagram illustrating an example of memory card fitted with a memory including photoelectric integrated circuit devices in accordance with example embodiments of the inventive concepts.

FIG. 25 is a block diagram illustrating an example of information processing system fitted with a memory including photoelectric integrated circuit devices in accordance with example embodiments of the inventive concepts.

### DETAILED DESCRIPTION OF EXAMPLE EMBODIMENTS

Example embodiments of the inventive concepts will be described below in more detail with reference to the accompanying drawings. The example embodiments of the inventive concepts may, however, be embodied in different forms and should not be constructed as limited to the embodiments set forth herein. Rather, these embodiments are provided so that this disclosure will be thorough and complete, and will fully convey the scope of the inventive concepts to those skilled in the art. Like numbers refer to like elements throughout.

The terminology used herein is for the purpose of describing particular embodiments only and is not intended to be limiting of the invention. As used herein, the singular foams “a”, “an” and “the” are intended to include the plural foams as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will also be understood that when an element such as a layer, region or substrate is referred to as being “on” or “onto” another element, it may lie directly on the other element or intervening elements or layers may also be present. Like reference numerals refer to like elements throughout the specification.

Example embodiments of the inventive concepts may be described with reference to cross-sectional illustrations, which are schematic illustrations of idealized embodiments of the present invention. In the drawings, the thickness of layers and regions are exaggerated for clarity. As such, variations from the shapes of the illustrations, as a result, for example, of manufacturing techniques and/or tolerances, are to be expected. Thus, embodiments of the present invention should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of the present invention.

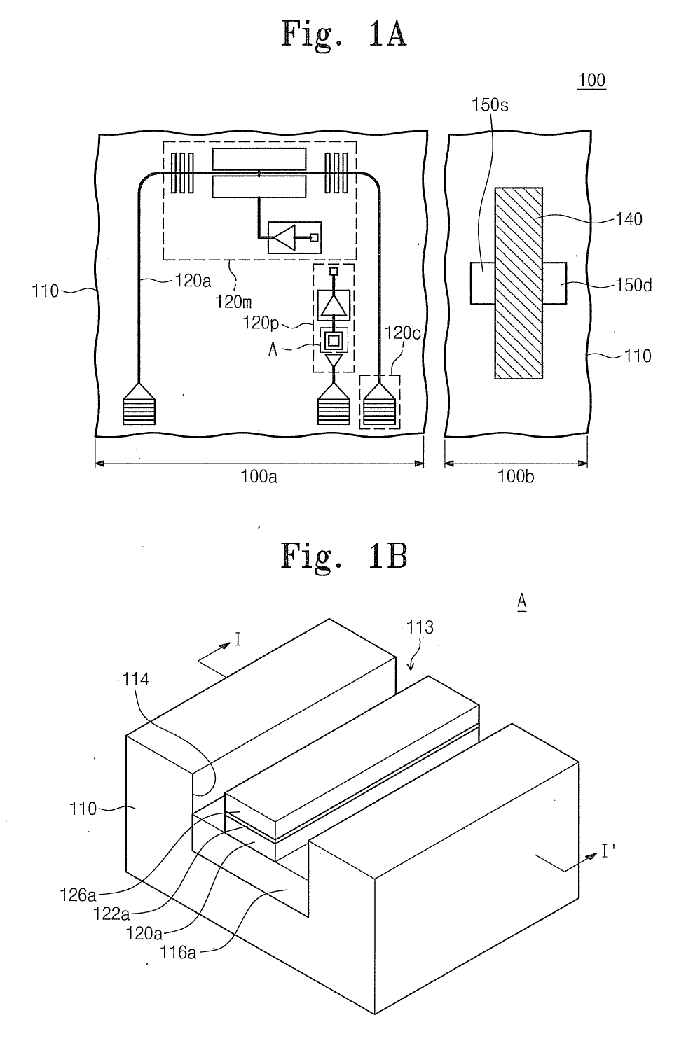

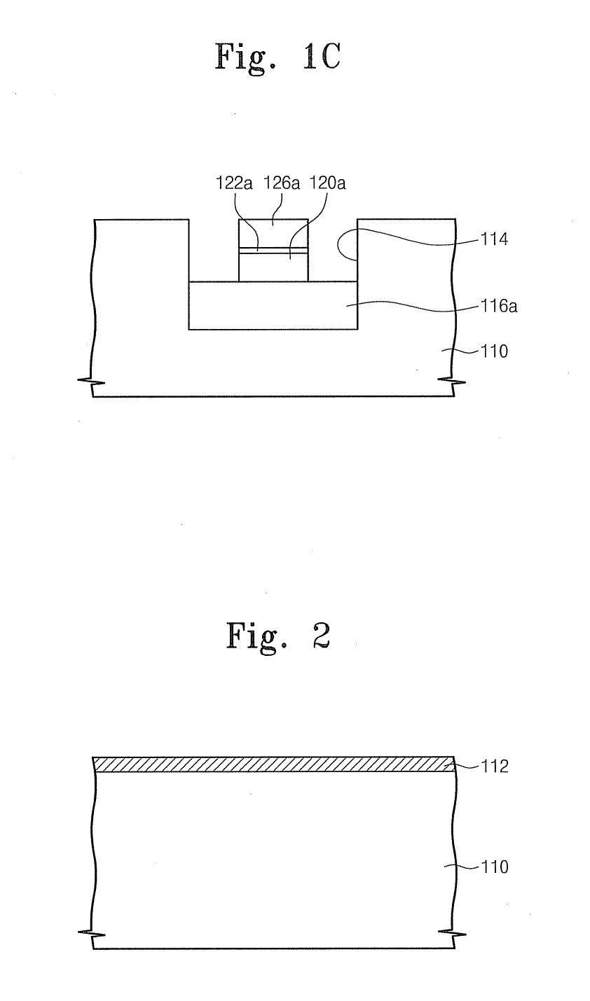

FIG. 1A is a top plan view illustrating a photoelectric integrated circuit device including an on die optical input/output device. FIG. 1B is an enlarged three dimensional view of “A” part of FIG. 1A. FIG. 1C is a cross sectional view taken along a line of I-I′ of FIG. 1B.

Referring to FIGS. 1A through 1C, a photoelectric integrated circuit device 100 includes an on die optical input/output device 100a and an electronic device 100b. The electronic device may include a transistor provided on a substrate 110. The transistor may be comprised of a gate 140 and a source/drain 150s/150d. Although a dynamic random access memory (DRAM) is illustrated as an electronic device in FIG. 1A, different memory cells may be provided on the substrate 110.

The on die photoelectric input/output device may include elements performing various functions including an optical signal transmission. Those elements may include an optical waveguide including a core 120a, a modulator 120m, a photodiode 120p, a coupler 120c or a grating. Those elements may be constituted by various type changes of optical waveguide or various type combinations of optical waveguide.

Referring to FIGS. 1B and 1C, the on die optical input/output device including the photodiode 120p in accordance with an example embodiment of the inventive concepts will be described in detail.

The on die optical input/output device includes the substrate 110 including a trench 113, a lower clad layer 116a having an upper surface lower than a surface of the substrate 110 provided in the trench 113, a core 120a provided on the lower clad layer 116a, an insulating pattern 122a provided on the core 120a and an optical detection pattern 126a provided on the insulating pattern 122a so that at least a portion of the optical detection pattern 126a is provided in the trench 113. The optical detection pattern 126a may have an upper surface having the same height as the surface of the substrate 110. The optical detection pattern 126a may be spaced apart from sidewalls 114 of the trench 113 facing each other in a direction crossing a direction in which the core 120a extends. In addition, the core 120a and the insulating pattern 122a may also be spaced apart from the sidewalls 114 of the trench 113 facing each other at the direction crossing the direction in which the core 120a extends.

The substrate 110 may be a bulk silicon wafer. The lower clad layer 116a may include silicon oxide (SiO₂). The core 120a may include single crystalline silicon. The single crystalline silicon may be formed by a laser induced epitaxial growth (LEG) method. Thus, the core 120a including single crystalline silicon may have a high refractive index compared with the lower clad layer 116a including silicon oxide.

The insulating pattern 122a may include at least one selected from silicon oxynitride (SiON) and silicon oxide. The optical detection pattern 126a may include single crystalline germanium. In the case of performing an epitaxial growth of germanium directly on the single crystalline silicon, crystal defects may naturally occur due to a difference of lattice constant between silicon and germanium. Those defects may become a main factor decreasing photoelectric conversion efficiency. However, since the single crystalline germanium constituting the optical detection pattern 126a is not directly in contact with the single crystalline silicon constituting the core 120a, the optical detection pattern 126a may be embodied which has no crystal defects naturally occurring due to the difference of the lattice constant between silicon and germanium at an interface of single crystalline germanium and single crystalline silicon. Also, although the optical detection pattern 126a is epitaxially grown in a state of directly being in contact with silicon of the substrate 110 corresponding to the sidewalls 114 of the trench 113, a portion where crystal defects occur is removed by an etching process for separating the optical detection pattern 126a from the sidewalls 114 of the trench 113, resulting in no crystal defects.

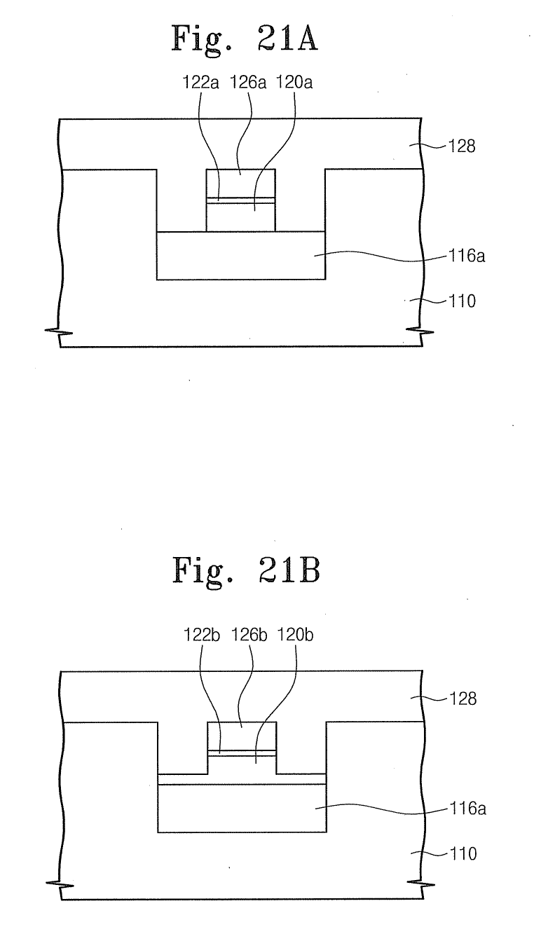

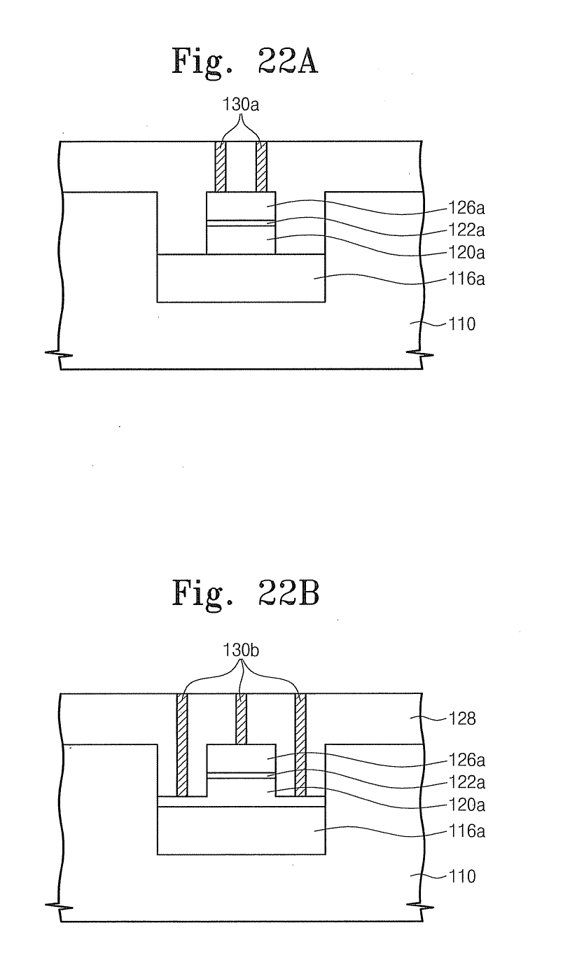

Although not illustrated in the drawing, the on die optical input/output device may further include an upper clad layer (refer to 128 in FIG. 21A or FIG. 21B) covering the optical detection pattern 126a. The upper clad layer may include material having a low refractive index compared with the core 120a. In addition, the on die optical input/output device may further include at least one electrode (refer to 130a in FIG. 22A or 130b in FIG. 22B) which penetrates the upper clad layer to be electrically connected to the optical detection pattern 126a.

Accordingly, a photodiode 120p comprised of the lower clad layer 116a, the core 120a, the insulating pattern 122a, the optical detection pattern 126a, the upper clad layer and the electrode may be provided on the substrate 110. Besides, an optical waveguide comprised of the lower clad layer 116a, the core 120a and the upper clad layer is provided on the substrate in various plane forms and thereby the on die optical input/output device may perform a function of transmitting an optical signal, a function of modulator 120m, a function of coupler 120c or a function of grating besides a function of photoelectric conversion.

The on die optical input/output device in accordance with example embodiments of the inventive concepts may provide the optical detection pattern without crystal defects because crystal defects of germanium layer of the optical detection pattern are controlled. Thus, the photoelectric integrated circuit device having an improved photoelectric conversion may be provided.

Also, since the optical detection pattern has the upper surface having the substantially same height as the surface of the substrate, in a subsequent process for integrating memory cells of electronic device, any adverse effects from a chemical mechanical polishing (CMP) process or the optical input/output device already formed may be prevented or reduced. Therefore, the photoelectric integrated circuit device having improved reliability may be provided.

Further, a step difference may be prevented from occurring at a region where the on die optical input/output device is coupled to an optical waveguide such as the modulator, the photodiode, the coupler or the grating having different widths of lower clad layer but also a difference of substrate thickness may be prevented from occurring on a same substrate or a different substrate.

Consequently, since the photoelectric integrated circuit device includes the on die optical input/output device in accordance with example embodiments of the inventive concepts, the photoelectric integrated circuit device may be miniaturized at a relatively low cost. Also, since the photoelectric integrated circuit device uses an optical signal, the photoelectric integrated circuit device may realize a relatively high speed signal transmission and a relatively high capacity of signal at a lower power.

FIGS. 2 through 22B are cross sectional views illustrating methods of forming an on die optical input/output device in accordance with example embodiments of the inventive concepts.

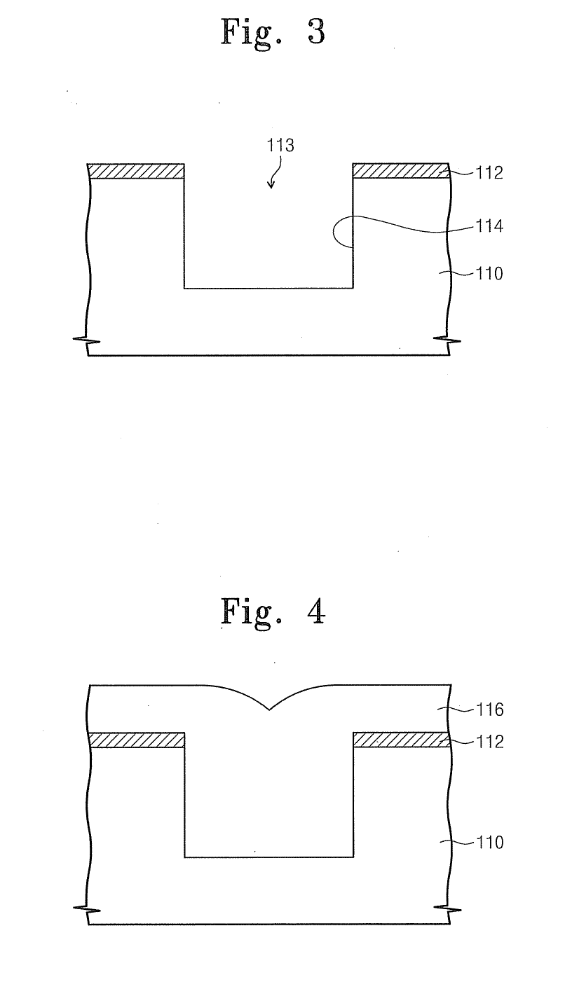

Referring to FIGS. 2 and 3, an etch-stop layer 112 is formed on a substrate 110. The substrate 110 may be a bulk silicon wafer. The etch-stop layer 112 may include a material having a high etching selectivity with respect to the substrate 110. The etch-stop layer 112 may include at least one selected from silicon nitride (SiN) and silicon oxynitride. The etch-stop layer 112 may be desirably a silicon nitride layer.

After the etch-stop layer 112 is patterned to expose a portion of the substrate 110, a trench 113 is formed by etching the substrate 110 using the etch-stop layer 112 as an etching mask. The trench 113 may have sidewalls 114.

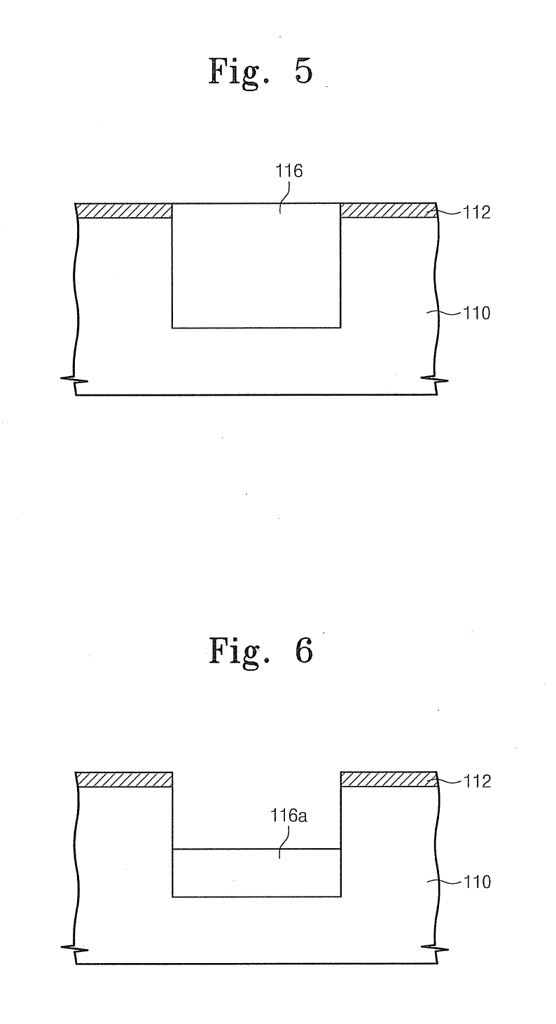

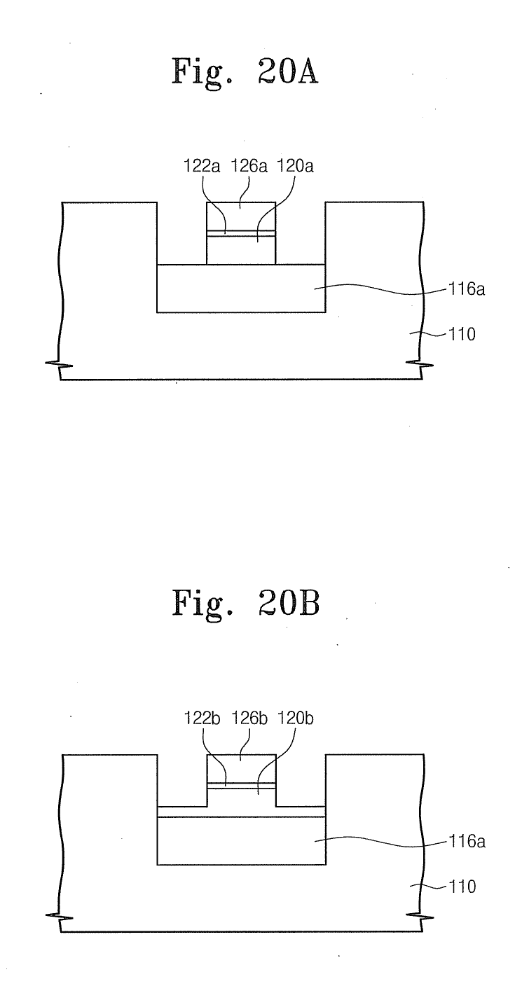

Referring to FIGS. 4 and 5, a lower clad film 116 covers the substrate 110 including the etch-stop layer 112 while filling the trench 113. The lower clad film 116 may include material having a low refractive index compared with a core (refer to 120a in FIG. 20A or 120b in FIG. 20B) formed in a subsequent process. The lower clad film 116 may include silicon oxide.

The lower clad film 116 is planarized to expose an upper surface of the etch-stop layer 112. The lower clad film 116 may be planarized by a chemical mechanical polishing (CMP) process. The etch-stop layer 112 may perform a function of indicating an end point of the chemical mechanical polishing (CMP) process planarizing the lower clad film 116.

Referring to FIG. 6, the planarized lower clad film 116 is recessed by an etching process using the etch-stop layer 112 as an etching mask. Thus, a lower clad layer 116a having an upper surface lower than a surface of the substrate 110 may be formed in the trench 113.

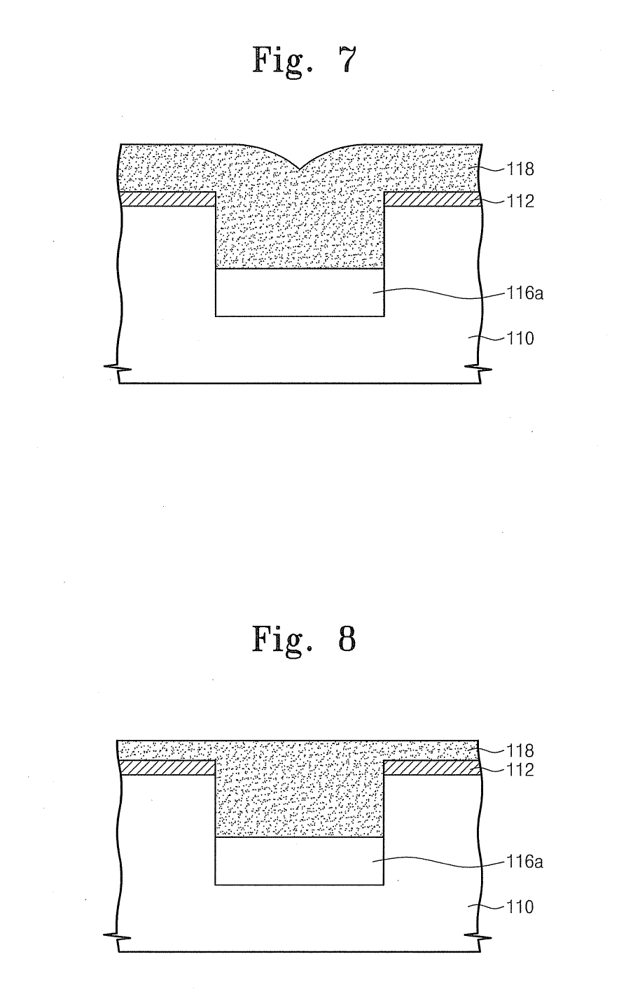

Referring to FIGS. 7 and 8, after forming an amorphous silicon film 118 covering the substrate 110 including the etch-stop layer 112 while filling the trench 113 in which the lower clad layer 116a is formed, the amorphous silicon film 118 is planarized to have a flat surface.

The amorphous silicon film 118 may be planarized using a partial CMP process. Thus, the amorphous silicon film 118 may remain on the etch-stop layer 112. The amorphous silicon film 118 remaining on the etch-stop layer 112 performs a function of an energy absorption layer in a subsequent process for crystallizing the amorphous silicon film 118 and thereby damage may be minimized or reduced such that the substrate 110 and the etch-stop layer 112 are deformed by a stress applied in a subsequent process.

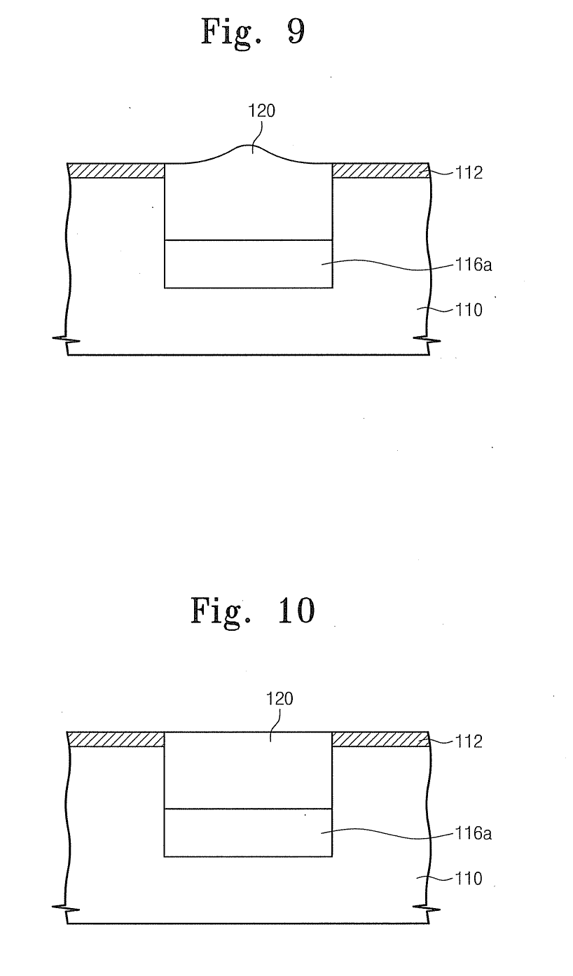

Referring to FIGS. 9 and 10, after forming a single crystalline silicon film 120 covering the substrate 110 including the etch-stop layer 112 while filling the trench 113 including the lower clad layer 116a by crystallizing the planarized amorphous silicon film 118, the single crystalline silicon film 120 is planarized to expose the etch-stop layer 112.

The planarized amorphous silicon film 118 may be changed to the single crystalline silicon film 120 using a laser. That is, the single crystalline silicon film 120 may be crystallized from the sidewalls 114 of the trench 113 by a laser induced epitaxial growth method.

The single crystalline silicon film 120 may be planarized by a chemical mechanical polishing (CMP) process. The etch-stop layer 112 may perform a function of indicating an end point of the chemical mechanical polishing (CMP) process planarizing the single crystalline silicon film 120.

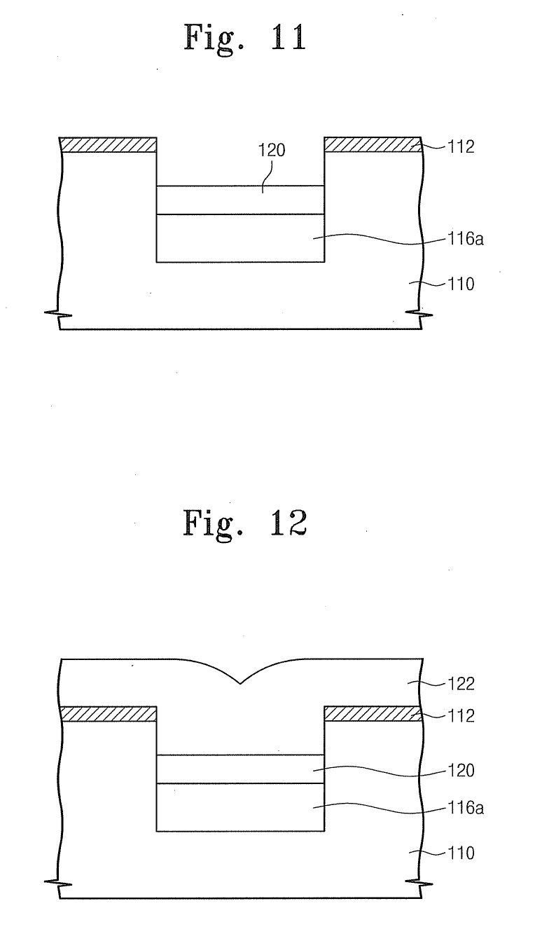

Referring to FIG. 11, the planarized single crystalline silicon film 120 is recessed by an etching process using the etch-stop layer 112 as an etching mask. As a result, the single crystalline silicon film 120 having an upper surface lower than the surface of the substrate 110 may be formed in the trench 113.

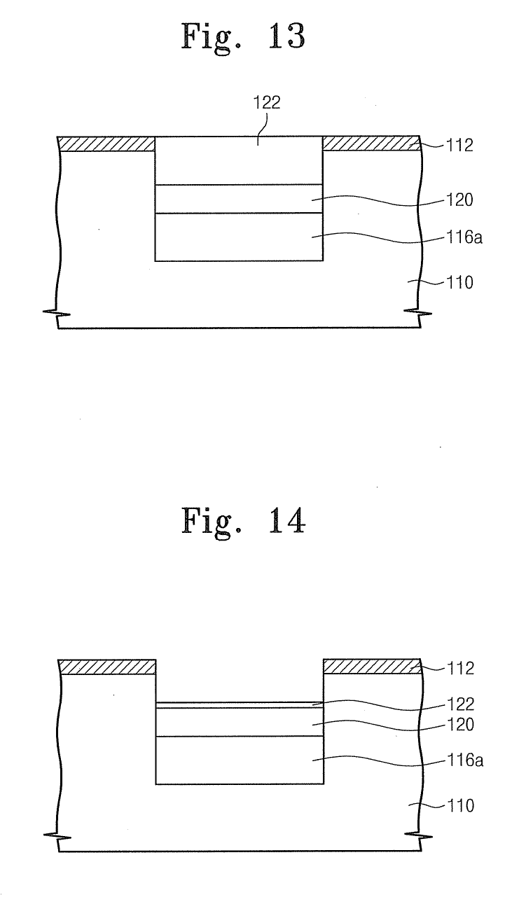

Referring to FIGS. 12 and 13, an insulating film 122 covering the substrate 110 including the etch-stop layer 112 while filling the trench 113 including the single crystalline silicon film 120 may be formed. The insulating film 122 may include at least one selected from silicon oxynitride and silicon oxide. The insulating film 122 may be a silicon oxide film.

The insulating film 122 is planarized to expose the upper surface of the etch-stop layer 112. The insulating film 122 may be planarized using a chemical mechanical polishing (CMP) process. The etch-stop layer 112 may perform a function of indicating an end point of the chemical mechanical polishing (CMP) process planarizing the insulating film 122.

Referring to FIG. 14, the planarized insulating film 122 may be recessed by an etching process using the etch-stop layer 112 as an etching mask. As a result, the insulating layer 122 having an upper surface lower than the surface of the substrate 110 may be formed in the trench 113.

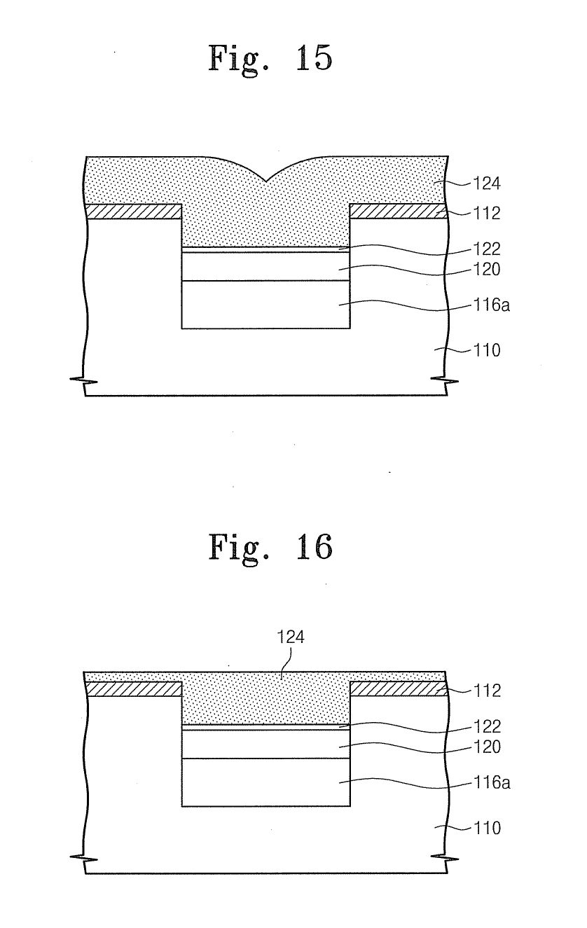

Referring to FIGS. 15 and 16, after forming an amorphous germanium film 124 covering the substrate 110 including the etch-stop layer 112 while filling the trench 113 in which the insulating layer 122 is formed, the amorphous germanium layer 124 is planarized to have a flat surface.

The amorphous germanium film 124 may be planarized using a partial CMP process. Thus, the amorphous germanium film 124 may remain on the etch-stop layer 112. The amorphous germanium film 124 remaining on the etch-stop layer 112 performs a function of an energy absorption layer in a subsequent process for crystallizing the amorphous germanium film 124. Thereby, damage may be minimized or reduced such that the substrate 110 and the etch-stop layer 112 are deformed by a stress applied in a subsequent process.

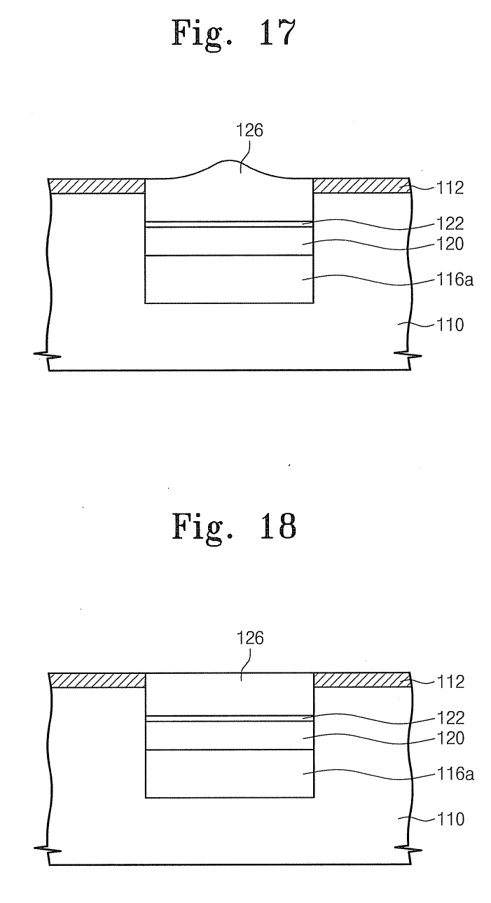

Referring to FIGS. 17 and 18, after forming a single crystalline germanium film 126 covering the substrate 110 including the etch-stop layer 112 while filling the trench 113 including the insulating layer 122 by crystallizing the planarized amorphous germanium film 124, the single crystalline germanium film 126 is planarized to expose the etch-stop layer 112.

The planarized amorphous germanium film 124 may be changed to the single crystalline germanium film 126 using a laser. That is, the single crystalline germanium film 126 may be formed by a laser induced epitaxial growth method. In order to change the amorphous germanium film 124 to the single crystalline germanium film 126, silicon of the substrate 110 corresponding to the sidewalls 114 of the trench 113 may be utilized as a seed. Therefore, crystal defects occurring due to a difference of lattice constant between silicon and germanium may exist at a part of the single crystalline germanium film 126 adjacent to the sidewalls 114 of the trench 113. However, crystal defects occurring due to a difference of lattice constant between silicon and germanium may not exist at the single crystalline germanium film 126 spaced apart from the sidewalls 114 of the trench 113.

The single crystalline germanium film 126 may be planarized using a chemical mechanical polishing (CMP) process. The etch-stop layer 112 may perform a function of indicating an end point of the chemical mechanical polishing (CMP) process planarizing the single crystalline germanium film 126. Thus, a thickness uniformity of the single crystalline germanium film 126 formed as an optical detection pattern (refer to 126a in FIG. 20A or 126b in FIG. 20B) in a subsequent process may be improved over an entire portion of the substrate 110. Also, a thickness uniformity of the substrate 110 may be improved.

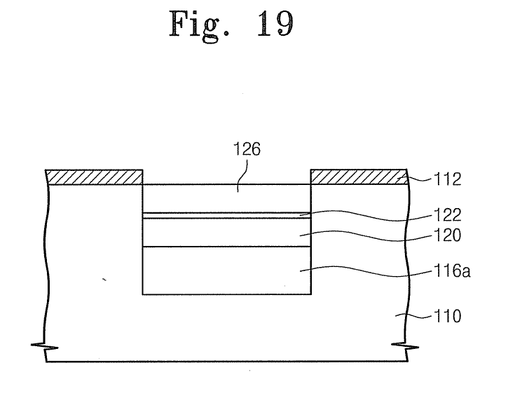

Referring to FIG. 19, the single crystalline germanium film 126 is etched using the etch-stop layer 112 as an etching mask so that an upper surface of the single crystalline germanium film 126 has substantially the same height as the surface of the substrate 110.

Referring to FIGS. 20A and 20B, the single crystalline germanium film 126, the insulating layer 122 and the single crystalline silicon film 120 are etched to form an optical detection pattern 126a or 126b having at least a portion provided in trench 113 and spaced apart from the sidewalls 114 of the trench 113 facing each other in a direction crossing a direction in which the single crystalline silicon film 120 extends. The optical detection pattern 126a may have an upper surface having the same height as the surface of the substrate 110.

Since the single crystalline germanium film 126 is formed in the trench 113 of the substrate 110, a boundary between the single crystalline germanium film 126 and the substrate 110 is obvious. The etch-stop layer 112 exists on the surface of the substrate 110. Thus, an active region of the substrate 110 may not be damaged during a process of etching the single crystalline germanium film 126, the insulating layer 122 and the single crystalline silicon film 120 to form a core 120a, an insulating pattern 122a and the optical detection pattern 126a.

FIG. 20A illustrates that besides the optical detection pattern 126a, the insulating pattern 122a and the core 120a are also spaced apart from the sidewalls 114 of the trench 113 facing each other in a direction crossing a direction in which the core 120a extends by etching the single crystalline germanium film 126, the insulating layer 122 and the single crystalline silicon film 120. Thus, the optical detection pattern 126a, the insulating pattern 122a and the core 120a may be formed to be surrounded by the lower clad layer 116a and an upper clad layer by a subsequent process forming the upper clad layer (refer to 128 in FIG. 21A or FIG. 21B).

FIG. 20B illustrates that the optical detection pattern 126b and the insulating pattern 122b are completely spaced apart from the sidewalls 114 of the trench 113 facing each other in a direction crossing a direction in which the core 102b extends by etching the single crystalline germanium film 126, the insulating layer 122 and the single crystalline silicon film 120 but only a portion of the core 120b is spaced apart from the sidewalls 114 of the trench 113 facing each other in a direction crossing a direction in which the core 120b extends by etching the single crystalline germanium film 126, the insulating layer 122 and the single crystalline silicon film 120. Accordingly, the optical detection pattern 126b and the insulating pattern 122b may be formed to be surrounded by the core 120b and an upper clad layer by a subsequent process forming the upper clad layer (refer to 128 in FIG. 21A or FIG. 21B) and the core 120b may be formed to be interposed between the lower clad layer 116a and the upper clad layer.

Since by changing the amorphous germanium film 124 to the single crystalline germanium film 126, a part of the single crystalline germanium film 126 adjacent to the sidewalls 114 of the trench 113 on which crystal defects occur due to a difference of lattice constant between silicon and germanium may be removed by etching the single crystalline germanium film 126, the insulating layer 122 and the single crystalline silicon film 120. Therefore, the optical detection pattern 126a or 126b having no crystal defects may be realized.

After forming the core 120a or 120b, the insulating pattern 122a or 122b and the optical detection pattern 126a or 126b, removing the etch-stop layer 112 may be further performed.

Referring to FIGS. 21A and 21B, an upper clad layer 128 covering the optical detection pattern 126a or 126b is formed. The upper clad layer 128 may include a material having a lower refractive index than the core 120a or 120b. The upper clad layer 128 may include at least one selected from silicon oxide, silicon oxynitride and silicon nitride. The upper clad layer 128 may also be replaced with a material such as an interlayer insulating layer formed by a subsequent process for integrating memory cells of the electronic device. The interlayer insulating film and the upper clad layer 128 may be formed at the same time.

Referring to FIGS. 22A and 22B, at least one electrode 130a or 130b penetrating the upper clad layer 128 to be electrically connected to the optical detection pattern 126a or 126b is formed. The electrode 130a or 130b may include a conductive metal material such as copper (Cu). The electrode 130a or 130b may also be replaced with a material such as a contact plug formed by a subsequent process for integrating memory cells of electronic device. The contact plug and the electrode 130a or 130b may be formed at the same time.

In FIG. 22A, the electrodes 130a are electrically connected to only the optical detection pattern 126a. On the other hand, in FIG. 22B, the electrodes 130b are electrically connected to not only the optical detection pattern 126b but also the core 120b. The electrodes 130a or 130b may be electrically connected to the optical detection pattern 126b and the core 120b in various forms according to shapes of the optical detection pattern 126b and the core 120b.

As a result, a photo diode (refer to 120p in FIG. 1A) comprised of the lower clad layer 116a, the core 120a or 120b, the insulating pattern 122a or 122b, the optical detection pattern 126a or 126b, the upper clad layer 128 and the electrode 130a or 130b may be provided on the substrate 110. Besides, an optical waveguide comprised of the lower clad layer 116a, the core 120a or 120b and the upper clad layer 128 may be provided on the substrate 110 in various flat fauns and thereby the optical input/output device may perform a function of transmitting an optical signal, a function of modulator, a function of coupler or a function of grating besides a function of photoelectric conversion.

In the on die optical input/output devices formed by the methods in accordance with example embodiments of the inventive concepts, since crystal defects of a germanium film whereby the optical detection pattern is controlled, the optical detection pattern having no defects may be formed. Thus, a method of manufacturing a photoelectric integrated circuit device may be provided that can improve photoelectric conversion efficiency.

Also, since the optical detection pattern is formed to have the upper surface having the substantially same height as the surface of the substrate, in a subsequent process for integrating memory cells of electronic device, any adverse effects to a chemical mechanical polishing (CMP) process or the optical input/output device already formed may be prevented or reduced. Therefore, a method of manufacturing a photoelectric integrated circuit device may be provided that can improve a yield.

Further, a step difference may be prevented or reduced from occurring at a region where the on die optical input/output device is coupled to an optical waveguide such as the modulator, the photodiode, the coupler or the grating having different widths of the lower clad layer, and also, a difference of substrate thickness may be prevented or reduced from occurring on a same substrate or a different substrate.

Consequently, since the photoelectric integrated circuit device includes the on die optical input/output device in accordance with example embodiments of the inventive concepts, the photoelectric integrated circuit device may be miniaturized at a relatively low cost, and since the photoelectric integrated circuit device uses an optical signal, a relatively high speed signal transmission and a relatively high capacity of signal at a low power may be realized.

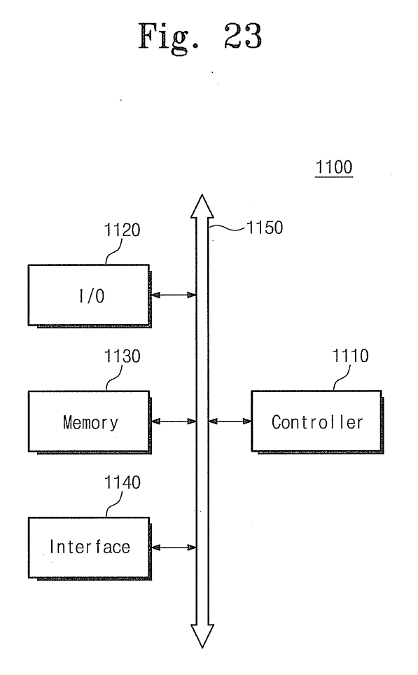

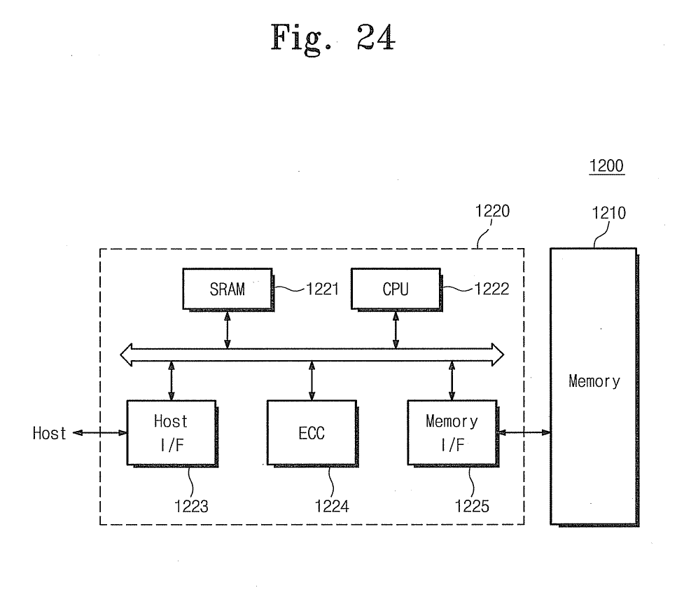

FIG. 23 is a block diagram illustrating an example of memory system fitted with a memory including photoelectric integrated circuit devices in accordance with example embodiments of the inventive concepts.

Referring to FIG. 23, the memory system 1100 may be applied to a personal digital assistant (PDA), a portable computer, a web tablet, a wireless phone, a mobile phone, a digital music player, a memory card or all the devices that can transmit and/or receive data in a wireless environment.

The memory system 1100 includes a controller 1110, an input/output device 1120 such as a keypad and a displayer, a memory 1130, an interface 1140 and a bus 1150. The memory 1130 and the interface 1140 communicate with each other through the bus 1150.

The controller 1110 includes at least one microprocessor, at least one digital signal processor, at least one micro controller or other process devices similar to the microprocessor, the digital signal processor and the micro controller. The memory 1130 may be used to store an instruction executed by the controller 1110. The input/output device 1120 can receive data or a signal from the outside of the memory system 1100 or transmit data or a signal to the outside of the memory system 1100. For example, the input/output device 1120 may include a keyboard, a keypad and/or a displayer.

The memory 1130 includes a memory device including photoelectric integrated circuit devices in accordance with example embodiments of the inventive concepts. The memory 1130 may further include a different kind of memory, a volatile memory device capable of random access and/or various other types of memories.

The interface 1140 may perform a function of transmitting data to a communication network or receiving data from a communication network.

FIG. 24 is a block diagram illustrating an example of memory card fitted with a memory including photoelectric integrated circuit devices in accordance with example embodiments of the inventive concepts.

Referring to FIG. 24, the memory card 1200 for supporting a storage capability of a large capacity is fitted with a memory device 1210 including a photoelectric integrated circuit device in accordance with an example embodiment of the inventive concepts. The memory card 1200 in accordance with an example embodiment of the inventive concepts includes a memory controller 1220 controlling all the data exchanges between a host and the memory device 1210.

A SRAM 1221 is used as an operation memory of a central processing unit 1222. A host interface 1223 includes data exchange protocols of a host connected to the memory card 1200. An error correction block 1224 detects and corrects errors included in data readout from the memory device 1210 having multi bit characteristics. A memory interface 1225 interfaces with the memory device 1210 including the photoelectric integrated circuit device of the inventive concepts. The central processing unit 1222 performs all the control operations for a data exchange of the memory controller 1220. Although not illustrated in the drawing, it is apparent to one of ordinary skill in the art that the memory card 1200 in accordance with an example embodiment of the inventive concepts can further include a read only memory (ROM) (not shown) storing code data for interfacing with the host.

According to the memory device including the photoelectric integrated circuit device of the inventive concepts, the memory card or the memory system, a high integrated memory system may be provided. In particular, the photoelectric integrated circuit device of the inventive concepts may be applied to a memory system such as a solid state drive (SSD). In this case, a high integrated memory system of high speed may be realized.

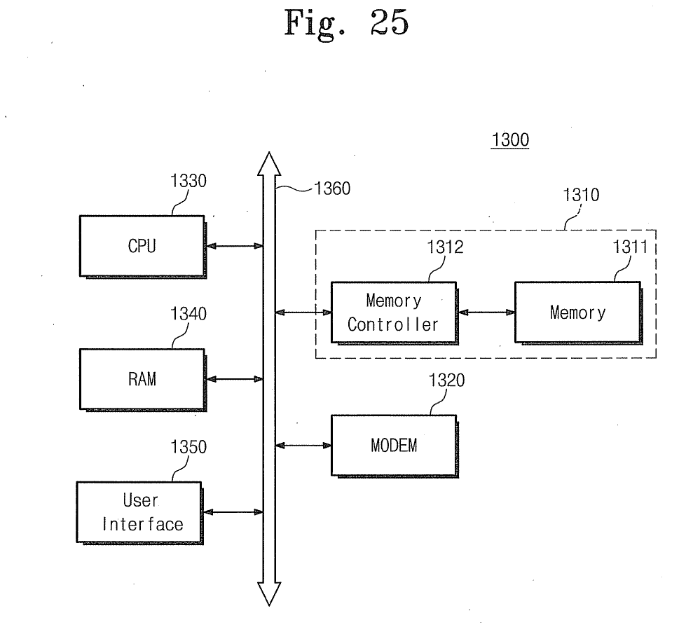

FIG. 25 is a block diagram illustrating an example of information processing system fitted with a memory including photoelectric integrated circuit devices in accordance with example embodiments of the inventive concepts.

Referring to FIG. 25, a memory system 1310 including a memory device 1311 including the photoelectric integrated circuit device and a memory controller 1312 controlling all the data exchanges between a system bus 1360 and the memory device 1311 is built in a data processing system 1300 such as a mobile device or a desk top computer. The data processing system 1300 in accordance with an example embodiment of the inventive concepts includes the memory system 1310 and a modem 1320, a central processing unit (CPU) 1330, a random access memory (RAM) 1340, a user interface 1350 that are electrically connected to a system bus 1360 respectively. The memory system 1310 may be constituted to be the same with the memory system described above. The memory system 1310 stores data processed by the central processing unit 1330 or data received from an external device. Here, the memory system 1310 may be constituted by a solid state disk (SSD) and in this case, the data processing system 1300 can stably store relatively large amounts of data in the memory system 1310. As reliability increases, the memory system 1310 can reduce resources used to correct errors, thereby providing a high speed data exchange function to the data processing system 1300. Although not illustrated in the drawing, it is apparent to one of ordinary skill in the art that the data processing unit 1300 in accordance with an example embodiment of the inventive concepts may further include an application chipset, an image signal processor (ISP) and/or an external input/output device.

The memory device or the memory system including the photoelectric integrated circuit device in accordance with an example embodiment of the inventive concepts can be mounted with various types of packages. For example, the memory device or the memory system can be mounted by various types of packages such as PoP (package on package), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIL), shrink small outline package (SSOP), thin small outline (TSOP), thin quad flat pack (TQFP), system in package (SIP), multi chip package (MCP), wafer-level fabricated package (WFP), and wafer-level processed stack package (WSP).

As described above, according to the inventive concepts, crystal defects of a germanium layer which is an optical detection layer may be controlled. Thus, since the optical detection layer having no crystal defects can be provided, a photoelectric integrated circuit device having improved photoelectric conversion efficiency can be provided. Also, the optical detection layer may have an upper surface having the substantially same height as a surface of a substrate. Accordingly, in a subsequent process for integrating memory cells of electronic device, any adverse effects to a chemical mechanical polishing (CMP) process or the optical input/output device already formed may be prevented or reduced. In addition, a step difference may be prevented or reduced from occurring at a region where a lower clad layer and an optical waveguide having a different width are coupled but also a difference of substrate thickness may be prevented or reduced from occurring on a same substrate or a different substrate.

1. A photoelectric integrated circuit device, comprising:
a substrate including an electronic device region and an on die optical input/output device region, the substrate having a trench in the on die optical input/output device region;
a lower clad layer in the trench, the lower clad layer having an upper surface lower than a surface of the substrate;
a core on the lower clad layer;
an insulating pattern on the core;
an optical detection pattern on the insulating pattern, the optical detection pattern having at least a portion provided in the trench; and
at least one transistor on the electronic device region.

2. The photoelectric integrated circuit device of claim 1, wherein the optical detection pattern is spaced apart from sidewalls of the trench in a direction crossing where the core extends.

3. The photoelectric integrated circuit device of claim 1, wherein the optical detection pattern has an upper surface having a same height as the surface of the substrate.

4. The photoelectric integrated circuit device of claim 1, wherein the substrate is a bulk silicon wafer.

5. The photoelectric integrated circuit device of claim 1, further comprising:
an upper clad layer covering the substrate on which the optical detection pattern is provided.

6. The photoelectric integrated circuit device of claim 5, further comprising:
at least one electrode penetrating the upper clad layer to be electrically connected to the optical detection pattern.

7-15. (canceled)

16. A photoelectric integrated circuit device, comprising:
a substrate including an on die optical input/output device region, the substrate having a trench in the on die optical input/output device region; and
at least a portion of an optical detection pattern in the trench, the optical detection pattern having an upper surface a same height as the surface of the substrate.

17. The photoelectric integrated circuit device of claim 16, wherein the substrate includes an electronic device region, further comprising:
a lower clad layer in the trench, the lower clad layer having an upper surface lower than a surface of the substrate;
a core on the lower clad layer;
an insulating pattern on the core;
the optical detection pattern on the insulating pattern; and
at least one transistor on the electronic device region.

18. The photoelectric integrated circuit device of claim 16, wherein the optical detection pattern is spaced apart from sidewalls of the trench.

19. The photoelectric integrated circuit device of claim 16, further comprising:
an upper clad layer covering the substrate on which the optical detection pattern is provided; and
at least one electrode penetrating the upper clad layer to be electrically connected to the optical detection pattern.

20. The photoelectric integrated circuit device of claim 16, wherein the substrate is a bulk silicon wafer.
